(19) United States
(12) Patent Application Publication
(10) Pub. No.: US 2007/0092420 A1
(43) Pub. Date: Apr. 26, 2007

(54) Blasting process of acidic gases in gaseous effluents

(75) Inventor: Biagio Passaro, Carugate (Milano) (IT)

Correspondence Address: THE FIRM OF KARL F ROSS, 5676 RIVERDALE AVENUE, PO BOX 900, RIVERDALE (BRONX), NY, 10471-0900, US

(73) Assignees: GRUPPO PUBLIC CONSULT S.P.A., 1-20149 MILANO (IT); PASSARO, BIAGIO, 1-20061 CARUGATE (MILANO) (IT)

(21) Appl. No.: 10/553,144

(22) PCT Filed: Sep. 24, 2003
(86) PCT No.: PCT/EP03/10620

§ 371 Date: Dec. 12, 2006

(30) Foreign Application Priority Data
Apr. 11, 2003 (IT) MI2003A000765

(51) Int. Cl. B01D 53/40

(52) U.S. Cl. 423/225

(57) ABSTRACT

Desulphurization and fixation process of low/high temperature acidic gases by injecting a stable CaO/water suspension produced through the control of the temperature and/or with the additino of additives: calcium lignin sulphonate, calcium sulphate with various concentrations and in the various forms and sulphuric acid as well as any chemical compound which contains sulphuric groups.

The present invention refers to a blasting process of gaseous acidic effluents for controlling emissions from coal-fired waste incineration or combustion stations.

Purification processes of gaseous effluents which use Calcium as means for absorbing acidic gases are based upon the use of calcium hydroxide Ca(OH)2 or calcium carbonate CaCO3 in powder form for dry plants or in acqueous solution for semi-dry or wet plants.

Calcium compounds and above all Ca(OH)2 and CaCO3 are recognised as the main absorbents for the removal of SO2 and of acidic gases from the combustion fumes. In dry or semi-dry removal systems the absorbent is injected in the form of fine powder or an a low temperature acqueous suspension in the gaseous flow, the latter case being known as a “spray drier” system.

In both cases the removal capability of the absorbent increases the approach of the fume temperature to the dew point; the sulphur dioxide is fixed to solid through chemical reaction or absorbtion accordino to the following reactions:
CaO+SO2→CaSO3
Ca(OH)2+SO2→CaSO3+H2O
Ca(OH)2→CaO+H2O
CaO+0.5O2+SO2→CaSO4

In the case of high temperature desulphurization the absorbent is injected as powder in the zone downstream of the flame to avoid the sintering reactions of the calcium oxide which forms by decomposition of the hydroxide.

A substantial research and development effort has been made to obtain high temperature direct desulphurization and using the boiler like a genuine chemical reactor.

Numerous in-boiler tests have been carried out, obtaining somewhat modest results of between 20 and 40% desulphurization using a Ca/S ratio of 2. This process has had very limited applications both due to the large quantity of absorbent required to reach the emission limits required by regulations and due to some side-effects in the boiler such as the dirtying of the tube bundles which limited the heat exchange.

This reaction is conditioned by the following parameters: the short reaction time in the optimal temperature range (1350-1000° C.) and the diffusion of the reactants through the product layer formed (sulphate). Indeed, the molar volume increases from 16.9 cm3/mole of CaO to 48 cm3/mole of CaSO4 with the formation of a very compact non-porous solid layer which limits the diffusion of reactants to the core of the particle still to react. For this reason, a substantial effort has been made to obtain highly porous reactant particles with a high surface area to increase the diffusion of SO2 through the surface layer of sulphate.

Very little attention has been paid to improving the properties of the particles, including their dispersability and fluidity, in order to decrease the diffusive resistance of the gas from the bulk phase to the surface of the particles and that is caused by the agglomeration of particles during the preparation of the sorbent, pneumatic transportation and injection.

The phenomenon of agglomeration of fine particles of calcium hydroxide when these are dispersed in air or fumes is well known but not the mechanisms which govern it and above all its dependency upon the starting carbonate and upon the methods of hydration.

In spray-drier systems the acqueous hydroxide suspension is atomised in the gaseous flow in order to obtain small well-mixed droplets for high penetration capability of the jet. The suspension droplets, due to their high water content, take a long time to evaporate (from 0.5 to 2 seconds according to the temperature and the size of the droplets) and at the same time enthalpy is removed from the fumes due to the large amount of water to be evaporated (the concentration by weight of the water is between 65% and 85%). The long evaporation time requires large reaction volumes with large cooling of the fumes. Moreover, the use of large quantities of water requires large tanks for preparing the suspension.

Another inefficiency derives from the large agglomeration produced during the preparation of the suspension and in the step of atomizing the particles which brings an overall decrease in the desulphurization capability.

Since the evaporation time is a function of the temperature, the humidity of the fumes, the size of the droplets and the solid content present and given that the best condition for the reaction is obtained when the temperature of the fumes is close to the dew point, the evaporation time shall be extremely high and therefore difficult to control above all in transitory conditions which can happen as the thermal load varies; in this situation the risk of wetting the fabric of the filter sleeve and of completely blocking the filtration is high.

In dry systems the powdered hydroxide can be prepared on site in a hydrater with high additional costs or else can be bought in powder from commercial suppliers; in both cases a dishomogeneous low-quality product is obtained.

A disadvantage of using hydroxide is storage for which silos must be used having a volume about three times greater than those necessary for CaO for the same number of calcium moles stored. This is due to the different molecular weight and bulk density.

The purpose of the present invention is that of realising a spray-drier type process for treating acidic fumes (SO2, HCl etc.) with high blasting efficiency by means of a stable acqueous CaO suspension.

This and other purposes of the present invention are accomplished by a blasting process of gaseous acid effluents which takes place by injecting a stable CaO/water suspension produced through the control of the temperature and/or with the addition of additives such as calcium lignin sulphonate, calcium sulphate of various concentrations and in the various forms and sulphuric acid as well as any chemical compound which contains sulphonic groups.

The present invention therefore discloses the preparation and use of calcium oxide (CaO) in acqueous suspension to be used as absorbent means of HCl, SO2 and/or other acidic gases present in incineration or combustion fumes in general.

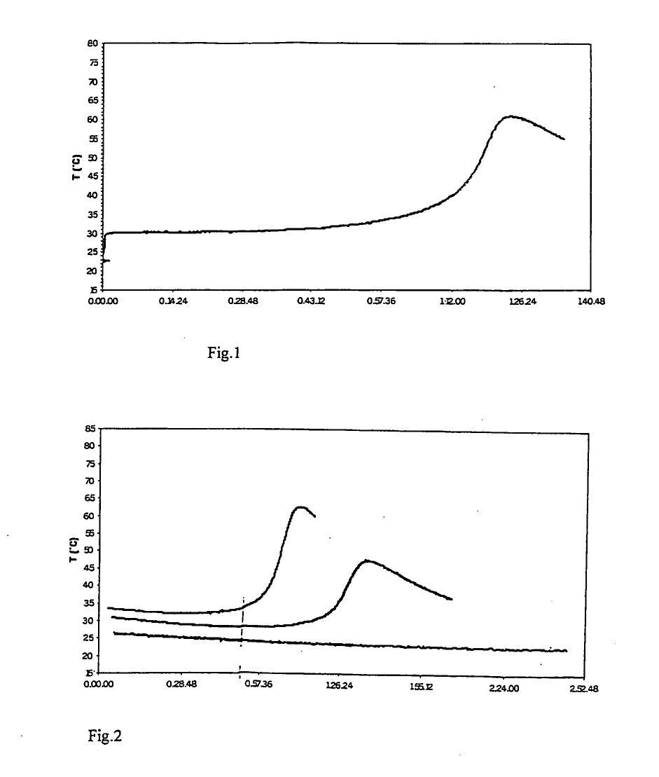

The following description of a preferred embodiment of the inventino refers to the attached FIG. 1 which illustrates the definition of stability time and to the attached FIG. 2 which illustrates the variation of the stability according to the temperature of the mixture.

In normal conditions the CaO (caustic lime) reacts with the water to produce calcium hydroxide Ca(OH)2 (hydrated lime) with a big release of heat (65 kJ/mole). This process allows a stable CaO-water suspension to be prapared controllino the temperature, the fluidodynamic conditions and adding special additives to prevent hydration, to improbe the reactivity of the reactant and to reduce the viscosity of the suspension.

The CaO hydration takes place durino evaporation and the consequent heating of the droplets takes place in the hot gaseous flow to be treated; with this technique the hydration heat which develops further increases the evaporation speed of the droplets with consequent fragmentation of the droplets and of the resulting Ca(OH)2 particles which have formed.

The calcium hydroxide particles thus produced have a high reactivity compared to the acidic gases due to the increase in porosity, to the surface area and the low size. The simultaneity of the Ca(OH)2 formation and the fixation of the acidic gases reduces the formation of the compact surface layer of calcium sulphate or sulphite, which tends to make the surface reactivity decrease, leads to a further advantage in terms of use of the reactant.

In this process acqueous suspensions with high CaO content which reach values up to 75% by weight if compared to the resulting Ca(OH)2 can be produced. Moreover, the calcium particles obtained possess high fluidity which ease both dry transportation and injection in acqueous solution.

The principles upon which this inventino is based are the possibilità of preventing the hydration of the CaO in the acqueous suspension to obtain hydration durino the atomisation and evaporation step of the droplets in the fumes to be treated, and the possibilità of injecting solutions with high solid content by means of atomisers to reduce the amount of water injected keeping the qualità of the dispersion of the reactant in the fumes.

With these techniques a solid product is obtained (a mixture of Ca(OH)2 and CaO) in fine extremely incoherent powder with very high surface area and porosity.

In order to evaluate the tendency of fine particles to agglomerate in clusters the cohesion factor was defined as the ratio between the average aerodynamic diameter, i.e. the average diameter of the particles measured dispersing them in air and the average diameter of the particles when they are dispersed in liquid and subjected to ultrasounds. Of course, the two measurements should be carried out using the same instrumental technique, for example laser ray diffraction. When the cohesion factor is ≦1 the particles do not agglomerate and they are perfectly dispersed in the gaseous phase.

The tests carried out to fine tune the process have shown that the cohesion factor is strictly correlated to the degree of hydration as an effect of additives and the temperature.

The stability of the acqueous solution of calcium oxide is a function of the type of oxide, of the temperature, of the fluidodynamic conditions, of the type of additive used and of the concentration of the additive.

Having kept the aforementioned parameters constant it is possible to define a stability time of the solution, i.e. the time passed from the preparation to the start of hydration (see FIG. 1). The stability time of the solution varies from a few minutes to many days. For practical purposes a solution stable for longer than an hour can be considered stable.

The tests carried out during the fine tuning of the process have shown that as the preparation temperature increases the stability time decreases (see FIG. 2); for temperatures of less than 35° C. any calcium oxide solution can be stabilised using a suitable consetration of additive.

The stability time increases as the concentration of the additive increases, until a concentration value is reached beyond which there is no variation.

The success parameters of the process are the control of the temperature and the presence of additives.

The temperature of the suspension must be controlled before atomisation.

The suspension must be continually kept in movement.

The main additives used are calcium lignin sulphonate in any form, calcium sulphate (from anhydride to bihydride) by itself or mixed with other salts and sulphuric acid, as well as volatile ashes containing sulphatic salts.

The additives which promote the high temperature reation are CaCl2 and HCl.

The economic advantages are clear since CaO costs less than hydroxide if compared on the molecular basis. A further decrease in costs derives from the greater reactivity of the Ca(OH)2 in nascent form produced during the atomisation process; a lower amount of reactant also implies lower amounts of calcic ashes to be disposed of and thus further cost benefits.

Beneficial effects are also reflected upon the engineering and the size of the apparatuses which are substantially small. For example, it is not necessary to have a hydration tank but just a simple mixer, with a lower volume can be the evaporation/reaction chamber due to the greater flowability of the calcic ashes which avoid problems in moving them.

The stable acqueous suspension of CaO can be atomised in a hot gaseous flow, from 60 to 1000° C., of fumes to be purified. If the suspension is evaporated in hot clean air a soft Ca(OH)2 powder is obtained; these particles have a high surface area (BET) according to the concentration and type of additive and the evaporation heat profile of the droplets.

The process tends to make the hydration speed coincide with the evaporation speed of the droplet, but in any case in the droplet (hydration in liquid phase) only a partial hydration of the CaO takes place (from 40 to 80%) leaving the completion of the hydration in gaseous phase (hydration in gas phase) with a further increase in the surface area of the hydroxide during the fixation phase of the acidic gases which, as has been highlighted, tends to make the surface area of the reaction product decrease.

In spray-drier type systems, the suspension droplets are initially heated using the substantial heat of the fumes (≦200° C.) but then using the great hydration heat of the CaO. In this way the risk of formation of wet skins on the fabric of the filtering sleeves is avoided.

After the heat has been recovered during hydration in the fumes, suspensions in water up to 25% CaO or temperatures of the fumes even close to the dew point of the fumes themselves can be used without there being problems of evaporation of the droplets and without the particles whilst still wet reaching the surface of the filters, clogging them up.

The injection downstream of the combustion zone is used to obtain very small particles of sorbent with high resistance to sintering. This objective is accomplished by adding CaCl2 or HCl to the suspension just before atomisation; the concentration of the CaCl2 must be between 0.1 and 1% by weight with respect to the oxide.

The CaCl2 has three different effects: it substantially increases the hydration speed during the evaporation of the droplets, it produces a calcium hydroxide with very low surface area (<3 m2/g) making it insensitive to heat sintering and increasing gaseous diffusion through the product layer.

In the preparation processes which shall be described hereafter the maximum concentration of solid (CaO) in the suspension can reach 75%, the residual water represents the amount of water necessary to hydrate all of the oxide present in theory providing a concentration of solid oxide in the particle equal to 100% (1 mole of H2O for one mole of CaO). In the solid concentration range between 40% and 65% the suspension has good reological properties relative to its viscosity and to the subsequent atomisation. There are no limits to the minimum concentration of solid in the suspension but for industrial applications we suggest a concentration of 25%.

The concentration of calcium lignin sulphonate (with or without sugars) is a function of the CaO concentration in suspension which one wishes to obtain and of the temperature of the suspension itself. In any case, with a water temperature lower than 30° C. the concentration of calcium lignin sulphonate must be more than 1% by weight in the water.

Calcium lignin sulphonate is commercialised in two different types: with sugars (35-40% sugars) and without sugars (5-10% sugars)—if in the preparation of the suspension the type with sugars is used the relative concentration of additive must be greater taking into account, however, that the type with sugar produces hydroxide particles with a greater surface area.

The milling time is a function of the size of the oxide particles desired; the finer the CaO particles, the better the results during the evaporation of the droplets and the hydration of the CaO. The minimum milling time of the CaO with a ball mill is 3 minutes.

Hereafter some examples of preparation are outlined, where the quantities are used as an example.

Method 1.

56 grammes of commercial calcium oxide and 1.11 grammes of calcium lignin sulphonate without sugar are mixed and ground in a ball mill until oxide particles with an average diameter of less than 10 microns are obtained. The powder is transferred into an agitator and mixed with 36 grammes of pure water or water added with the same calcium lignin sulphonate. In this suspension the CaO will not hydrate if the temperature of the suspension does not exceed 30° C. and the agitator remains in operation.

Method 1.bis

The same preparation methods as method 1 but using calcium sulphate (from anhydride to bihydride) as additive. In this case the water must only be saturated with calcium sulphate or else calcium lignin sulphonate can be used.

Method 2.

56 grammes of commercial calcium oxide and 1.11 grammes of calcium lignin sulphonate without sugar are mixed and ground together with 36 grammes of water in a wet ball mill until oxide particles with an average diameter of less than 10 microns are obtained, with these milling methods the overall time to reach the predetermined size is less than dry milling foreseen in method 1 and 1.bis. During milling the CaO does not hydrate if the temperature of the system does not exceed 30° C.

Method 2.bis

The same as method 2 but using sulphuric acid as additive to the water.

Method 3.

56 grammes of commercial calcium oxide with particles having an average diameter of less than 10 microns are transferred into a mixer with a mixing blade which has a high agitation speed. An acqueous solution of calcium lignin sulphonate (3% calcium lignin sulphonate by weight) is simultaneously added into the agitator, after a quick mixing which has the sole purpose of breaking the build-ups of CaO particles the suspension can be sent to the atomisers. During the mixing and the subsequent transportation the CaO does not hydrate if the temperature of the system does not exceed 30° C.

1) Blasting process of acidic gases in gaseous effluents characterised in that it consists of atomising, in the gaseous flow of combustion fumes to be purified, a stable acqueous suspension of calcium oxide (CaO) as means for absorbing the acidic gases present in them.

2) Blasting process of acidic gases in gaseous effluents according to claim 1, characterised in that the hydration of the calcium oxide takes place during the evaporation step and the consequent heating of the droplets of said stable acqueous suspension of calcium oxide injected into said gaseous flow.

3) Blasting process of acidic gases in gaseous effluents according to claim 1, characterised in that it uses the hydration heat which develops during the atomisation of said stable acqueous solution of calcium oxide in said gaseous flow to increase the evaporation speed of said droplets to fragment them together with the particles of calcium hydroxide which have formed.

4) Blasting process of acidic gases in gaseous effluents according to claim 1, characterised in that said particles of calcium hydroxide which have formed have an increase in their porosity, their surface area and a reduced size which increases their surface reactivity.

5) Blasting process of acidic gases in gaseous effluents according to claim 1, characterised in that said stable acqueous suspension contains up to 75% solid content of calcium oxide calculated based upon solid after drying, i.e. on Ca(OH)2.

6) Blasting process of acidic gases in gaseous effluents according to claim 1, characterised in that the temperature of said stable acqueous suspension of calcium oxide (CaO) is predetermined and controlled before its atomisation.

7) Blasting process of acidic gases in gaseous effluents according to claim 1, characterised in that said acqueous suspension is continually kept in movement.

8) Blasting process of acidic gases in gaseous effluents according to claim 1, characterised in that said stable acqueous suspension of calcium oxide (CaO) contains CaCl2 and HCl as additives.

9. Blasting process of acidic gases in gaseous effluents according to claim 1, characterised in that the CaCl2 or l′HCl are added to said suspension just before the atomisation step.

10. Blasting process of acidic gases in gaseous effluents according to claim 1, characterised in that the concentration of CaCl2 is substantially between 0.1% and 1% by weight with respect to the calcium oxide.

11) Blasting process of acidic gases in gaseous effluents according to claim 1, characterised in that said stable acqueous suspension of calcium oxide (CaO) contains one or more of the following additives: calcium lignin sulphonate, calcium sulphate with various concentrations and in the various forms and sulphuric acid as well as any chemical compound which contains sulphuric groups.

12) Blasting process of acidic gases in gaseous effluents according to claim 1, characterised in that said suspension is atomised in combustion fumes or clean gases (air) at a temperature greater than 60° C.

13) Blasting process of acidic gases in gaseous effluents according to claim 1, characterised in that with a temperature of the water of said stable acqueous suspension of calcium oxide (CaO) of less than 30° C. the concentration of calcium lignin sulphonate is substantially greater than 1% by weight in the water.

14) Procedure for producing an acqueous suspension based upon calcium oxide for use in a blasting process of acidic gaseous effluents, characterised in that said suspension is stabilised through the control of the temperature and/or with the addition of additives such as calcium lignin sulphonate, calcium sulphate, sulphuric acid as well as any chemical compound which contains sulphuric groups.

15) Acqueous suspension realised in accordance with the procedure described in claim 14.
